(19) United States
(12) Patent Application Publication
(10) Pub. No.: US 2022/0133078 A1
(43) Pub. Date: May 5, 2022

(54) METHOD AND MACHINE FOR EMULSIFYING MILK

(71) Applicant: CREM INTERNATIONAL SPAIN, S.L., Gandia (ES)

(72) Inventors: Juan Antonio Canet Peiro, Gandia (ES); Ivan Albano Garcia Lara, Valencia (ES)

(73) Assignee: CREM INTERNATIONAL SPAIN, S.L., Gandia (ES)

(21) Appl. No.: 17/437,926

(22) PCT Filed: Mar. 6, 2020
(86) PCT No.: PCT/IB2020/051979

§ 371 Date: Sep. 10, 2021

(30) Foreign Application Priority Data
Mar. 12, 2019 (ES) P201930228

(51) Int. Cl. A47J 31/44; A47J 31/60

(52) U.S. Cl. CPC A47J 31/4489; A47J 31/60

(57) ABSTRACT

A method and a machine for emulsifying milk, of the kind having a steam wand in a professional coffee-making machine, having means of producing different technical characteristics of the emulsion depending on the taste of the consumer through the use of different nozzles and at least one control unit to adjust the parameters of temperature, air and steam flow rate, for an optimal degree of emulsification. It has an automatic internal cleaning system for the steam wand once the emulsion cycle is finished, operated by a unit that controls the steam coming from the boiler in order to guarantee proper aseptic conditions for the unit, as well as safety elements to prevent the risk of burns to the user upon detecting the position of the wand, allowing or preventing the issuance of steam from it. Intended for the industrial sector dedicated to the manufacture of coffee-making machines.

### BACKGROUND

### 1. Field of the Disclosure

### 2. Discussion of the Background Art

As is known, milk is an indispensable complement in the making of various beverages, such as coffee, balancing the experience and originality in the enjoyment of a cappuccino or a latte macchiato, for example. Various means exist in professional coffee-making machines to accomplish the emulsifying of milk; on the one hand, the preparation of the emulsion may be conducted manually; in this method, a conventional steam wand is introduced into a receptacle, preferably one of metal, and the steam is released at the same time as simultaneous vertical, rotational or inclination movements are performed; this requires some skill to achieve a quality emulsion, while at the same time involving considerable time. To provide a technical solution without needing the involvement of an experienced user, machines are known which incorporate a milk receptacle and means of aspirating the milk, such as using a pump, or by means of the Venturi effect, employing for this an emulsion chamber where both fluids, steam and milk, are emulsified; this solution can be found in patent ES1040055U of the applicant Gaggia Española S.A. Other solutions are designed as an accessory located at the end of the steam wand, comprising an aspiration chamber, an opening in contact with the milk, another one communicating with the atmosphere, and a third one as the outlet for the emulsion; this innovation is registered by the applicant Moulinex S.A. in the European patent with application number 0555767 or in others that are based on a steam wand creating an attachable emulsifier at whose ends the milk is suctioned by the Venturi effect, such as the disclosure contained in the patent with publication number ES 200202804 of the applicant Sitexpress S.L.

Innovations are also known which improve these emulsion chambers by increasing the dwell time of the milk in them, as well as optimizing the circulation and dynamics of the fluids by nozzles and steps, as can be found in the European patent with application number 99969317.9 of the assignee Jura Elektroapparate AG.

On the other hand, it is known to be necessary to clean the interior of the steam wand and possibly the mixing chamber of the emulsion in order to guarantee hygienic conditions for the unit, the technical proposals being addressed to improving the conditions of disassembly of the units, as well as designing their geometries to avoid the creating of spaces of difficult access, clearly differing from the one being proposed, which furthermore includes means of protecting the user against the risk of burns from steam generated in the automatic cleaning of the emulsion equipment.

Therefore, no methods or corresponding machines are known, such as the one set forth in the present disclosure.

To provide coffee-making machines equipped with a steam wand intended to warm and emulsify milk for the preparation of various beverages with means for improving the quality of the emulsion in a simple and efficient manner without the need for the skill of an expert professional, such as a barista, since it is possible to vary the number and size of the bubbles of the emulsion created as a function of the time and quality desired by the user. To guarantee the proper interior cleaning of the steam wand, taking into account whether a manual cleaning has been conducted and whether this has been sufficient, initiating an automatic cleaning if necessary and avoiding the risk of burns to the user in the automatic cleaning routine by way of safety means integrated in the machine.

### SUMMARY

The proposed method and machine makes it possible to achieve in automated manner a quality milk emulsion which is only achieved by some professionals and which requires considerable time in the normal work rhythm, on the other hand having means for guaranteeing the proper interior cleaning of the steam wand as well as the safety of the user; accordingly, as set forth in the first claim, the emulsion is initiated after the user activates a selector switch toggle, thereby imitating the most intuitive experience of machines with mechanical opening of valves, so that when the described toggle is moved into one of its positions for making the emulsion, the method involves the reading of the temperature of the milk by means of a temperature probe that the steam wand has at its end and is in contact with the milk; if the temperature of the milk is higher than a setpoint value of 12° C., an indication will appear on a visual and touch screen that the milk should be cooled down as a recommendation; if the milk is below this temperature, the method will initiate the emitting of steam through the wand; after a time of 2 seconds, air is introduced from an adjustable pump, producing the mixture of steam/air in a chamber located at the beginning of the wand; after this, the temperature of the incipient emulsion is measured and a value prior to the final temperature is considered where the method cuts off the supply of air, but not that of steam, which allows the emulsion to not increase in volume and to become homogenized. The method calls for stopping the issuance of steam as a safety measure if the selector switch toggle is again activated in another of its positions or if an operating time in the emulsion position of around 240 seconds is exceeded. Once the emulsion is finished, a timer is initialized to perform an automatic cleaning; during this time, the user can perform an interior cleaning of the steam wand by again activating the selector switch toggle in the position selected for this purpose, thereby opening the steam valve until the toggle is moved to a neutral position (not activated); the method verifies whether the time has been sufficient, indicating that it is not by means of an alert on the visual touch screen that a cleaning should be performed again; if this is not done, or if the optimal time has not passed, the method will initiate an automatic cleaning which, to prevent the steam from reaching the user, will only be started when the steam wand is in a vertical position, therefore pointing at the spill tray of the coffee-making machine; this consideration is realized by interpreting the signal of a micro contact switch located at the upper portion of the steam wand.

The proposed machine to carry out the described method has a conventional steam wand, through which both the steam coming from the boiler and the air injection passes, these being mixed in a chamber near the beginning of the steam wand, the air being supplied by a regulable pump; it likewise comprises a temperature probe for measuring the temperature of the milk emerging from the wand through at least one interchangeable nozzle, the interchangeable nozzles making it possible to adjust the quality of the emulsion and the time needed to produce it, there being provided a nozzle with a single channel and outlet orifice having a diameter between 1.1 mm and 1.4 mm and whose channel is angled relative to the vertical axis of the wand between 20° and 40° so that the outgoing steam does not make direct contact with the temperature probe, distorting the measurement; on the other hand, when we wish to produce an emulsion more quickly without overly detracting from the quality, there is provided the use of another removable nozzle having 8 channels and orifices of identical orientation with diameters between 1.1 mm and 1.4 mm; both nozzles each have several parallel flat faces to facilitate their mounting and removal with the use of a fixed wrench.

The machine for emulsifying milk has at least one control unit, at least one memory for setting the default values or values introduced by the users, and a time base for setting the reference time of the events. It has a visual touch screen for data entry and output, as well as an electrical toggle switch for activating the routines for emulsion and interior cleaning of the steam wand, which are initiated according to the selected position of said switch. It has means for preventing the steam from reaching the user upon initiating an automatic cleaning by recognizing whether the steam wand is in the vertical position, such as a micro switch situated near the top portion of the wand, said position being determined by whether or not it is in contact, so that steam will only emerge in this position, directed toward the spill tray of the coffee-making machine.

### BRIEF DESCRIPTION OF THE DRAWINGS

FIG. 1 is a flow chart for the method of emulsification of milk, which is initiated by the activation of the selector switch toggle in one of its positions, in this case indicated as being the lower position.

FIG. 2 shows the manual cleaning procedure, initiated by activating the selector switch toggle in the upper position.

FIG. 3 illustrates the automatic cleaning procedure.

FIG. 4 shows an isometric view of a professional coffee-making machine, where 6 represents the spill collection tray.

FIG. 5 is an enlargement illustrating the selector switch toggle 1 in its neutral position and, by broken line, two positions for its activation: the upper and lower position. The visual touch screen 2 and the steam wand 3, both in the vertical and in the displaced position (shown by broken line) can be seen; at the end of the wand there is seen the removable outlet nozzle 4, and the temperature sensor 5.

FIGS. 6 and 7 show a removable nozzle with a single outlet opening; in its isometric representation, one of the planar faces can be seen, designed to facilitate the mounting and removal with a flat wrench.

FIGS. 8 and 9 show a removable nozzle with 8 outlet orifices.

FIGS. 10, 11 and 12 correspond to different milk emulsion samples, all of them using a scale bar at the right, where the perforations correspond to 200 microns, graphically superimposing several circumference lines to facilitate the visualization and interpretation of the samples. FIG. 10 is an emulsion sample produced manually by an inexperienced user; FIG. 11 shows a sample produced by the described method and machine with a nozzle having 8 orifices of 1.2 mm diameter; and analogously, FIG. 12 shows a sample in which the nozzle has a single orifice with a diameter of 1.3 mm.

FIGS. 13 and 14 show the counts and an analysis of the previous samples, comparing the number and size of the bubbles obtained per cm².

### DETAILED DESCRIPTION OF THE PREFERRED EMBODIMENT

As an example, a preferred embodiment shall be given, the subject matter of the disclosure being independent of the materials used in the manufacture of the machine for emulsification of milk, and the methods of application and all the accessory details which may be present in the method, provided they do not affect its essential nature.

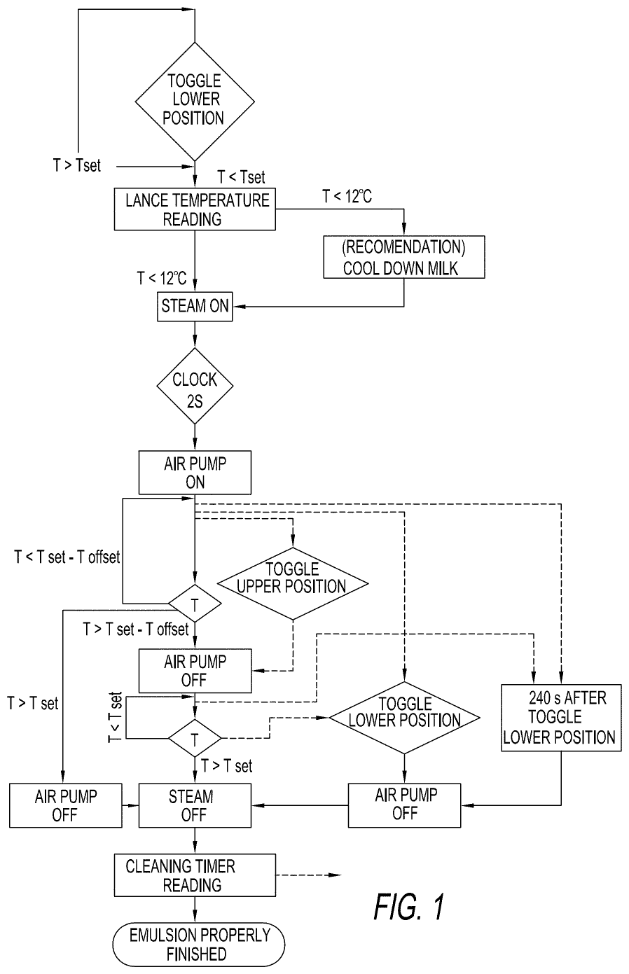

A preferred embodiment of the disclosure is presented, involving a method for obtaining an emulsion of milk in automated manner, achieving an optimum quality of emulsion without needing for this the skill of a professional and having the advantage of being reproducible whenever so required, under identical conditions. The milk emulsification is illustrated in the flow chart of FIG. 1 and it commences with the activation of the electrical toggle switch 1, FIG. 5, in the position selected for this function, which as an example here, may be considered as being the toggle in the lower position; in this way, a measurement is taken of the temperature of the milk, initiating the exiting of the steam through the steam wand 3; if the temperature is less than a value considered to be the optimum, which in this preferred embodiment is estimated to be 12° C., a recommendation is shown on the visual touch screen 2 to cool down the milk; the method generates a delay in the injecting of air of around 2 seconds after the issuing of steam, and it also measures the temperature of the milk, cutting off the injecting of air 14° C. prior to the final desired temperature, which is around 62° C., this cutting off of the supply of air, but not that of steam, allowing a homogenization of the emulsion without the emulsion continuing to increase.

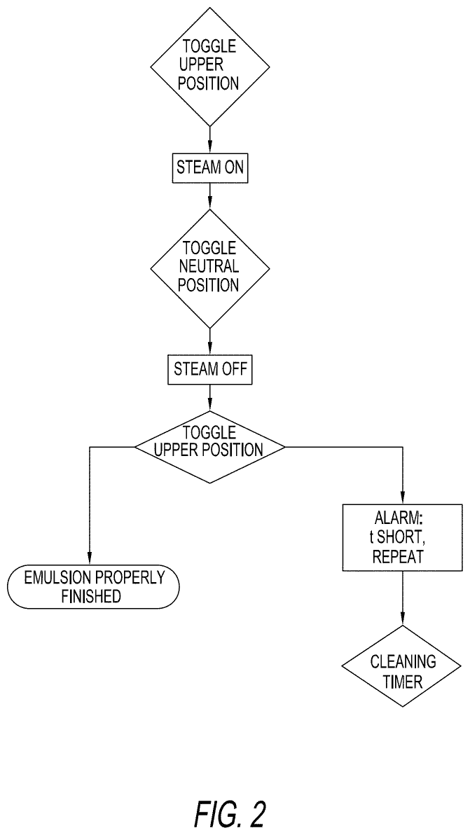

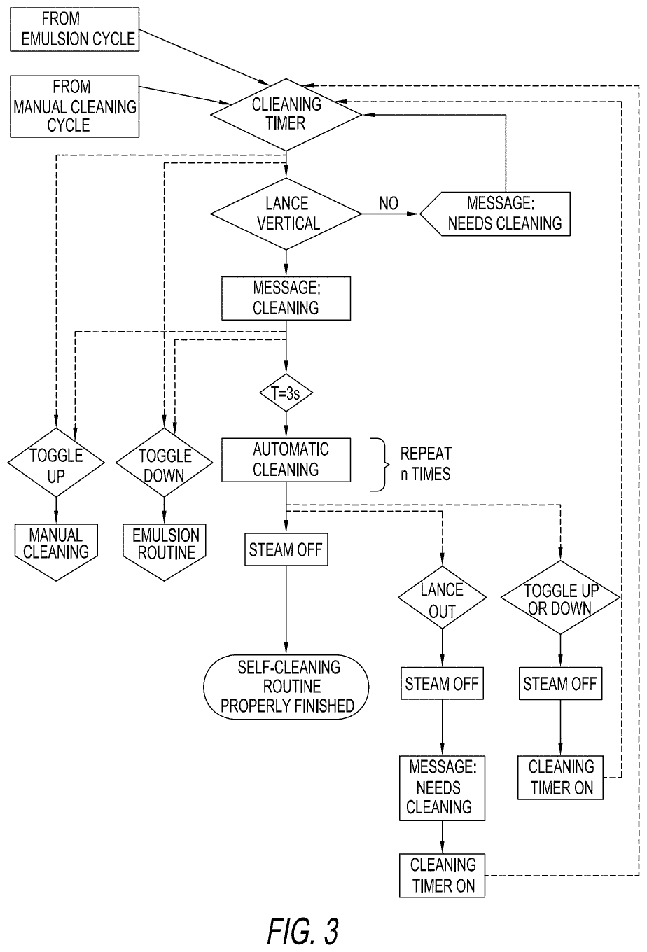

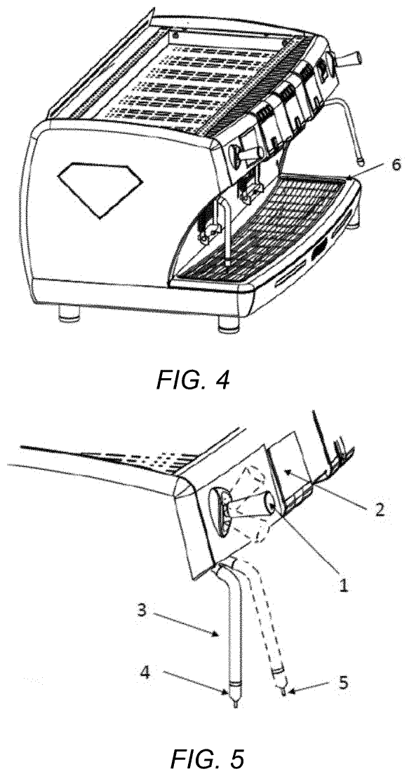

In this embodiment, one may perform the procedures for internal cleaning of the wand both manually, as illustrated in FIG. 2, and automatically, FIG. 3, which is described to provide further clarity: this mode is initiated after completing the emulsification and after initializing a timer, which contains a maximum predetermined value in at least one memory since its last use, i.e., if a maximum time has passed since its use and it has not been manually cleaned, automatic cleaning will be initiated, or, if the time for manual cleaning was inadequate, with respect to another factory default value as security; once the automatic cleaning is initiated, the method verifies that the steam wand is in the vertical position and therefore directed toward the spill collection tray 6, thereby preventing steam from reaching the user; otherwise, an alarm is generated, being shown on a touch display screen and indicating this event. The automatic cleaning is programmed, defining the time for issuance of steam and the time for its stoppage, as well as the necessary cycles; in this embodiment, three cycles are performed, each of them carrying out a steam issuance of 3 seconds and 1 second of waiting time, this combination achieving an adequate interior cleaning of the steam wand. When the cleaning is finished, a message is shown, indicating that the self-cleaning has been properly finished.

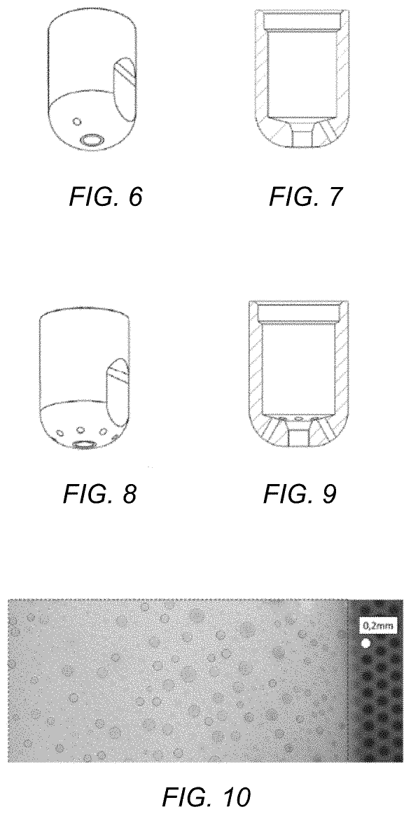

The machine for the method of this preferred embodiment comprises a control unit, at least one memory for storing the default operating parameters as well as those modified by the users, and a time base for setting the events. It has data input and output means via a touch display screen 2, and a selector switch toggle 1 for initiating the emulsion or proceeding with the manual cleaning of the steam wand. For the injecting of air it has a regulable peristaltic pump, at least one temperature probe 5 to perform the measurement of the temperature of the milk, and at least two interchangeable nozzles, FIGS. 6 and 8. It likewise comprises means for being able to prevent burns to the user from the steam of the wand when the automatic cleaning is being conducted, these means composed of detecting the position of the wand, for which it has a micro switch located near the upper part of the wand and whose contact determines this position, while its logical control unit prevents the escaping of steam if the described circumstance is not fulfilled.

The nozzle used in this embodiment has a single orifice with a diameter of 1.3 mm, this value allowing it to achieve an emulsion of high quality (emulsion shown in FIG. 12), while the cleaning is conducted adequately without its size causing it to become obstructed, such as occurs with orifices of less than 1.1 mm; the exit channel of the nozzle has an inclination of 30° with respect to the longitudinal axis of the wand, this angle allowing the steam to not impinge directly on the temperature probe 5, thereby disrupting its reading.

Example of the Emulsions Produced

To illustrate the effectiveness achieved with the proposed method and machine, three examples of emulsion are shown, in which one can make a comparison of the size of bubbles obtained and their distribution. All of the emulsions were produced under the same conditions of milk temperature and milk characteristics, specifically, a standard whole milk with a fat content of 3.6 g (saturated fat 2.4 g), 4.6 g of sugar, 0 g of salt, and a protein content of 3.1 g.

In order to display more clearly the photomacrographs, there has been placed at the right of the image a calibrated mesh having perforations of 200 microns, as well as a graphical superimposing of circles of the most representative sizes of the samples.

FIG. 10: sample obtained manually by an inexperienced user

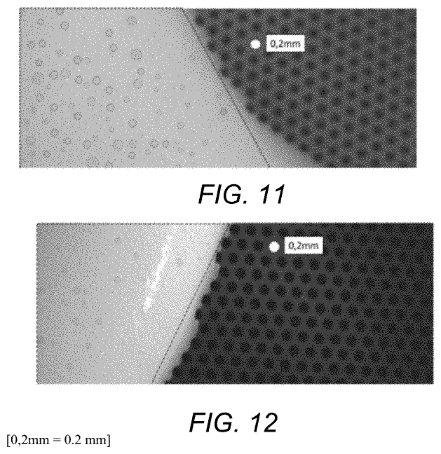

FIG. 11: sample obtained by using a nozzle having 8 orifices of 1.2 mm (FIGS. 8 and 9)

FIG. 12: sample obtained by using a nozzle having 1 orifice of 1.3 mm (FIGS. 6 and 7)

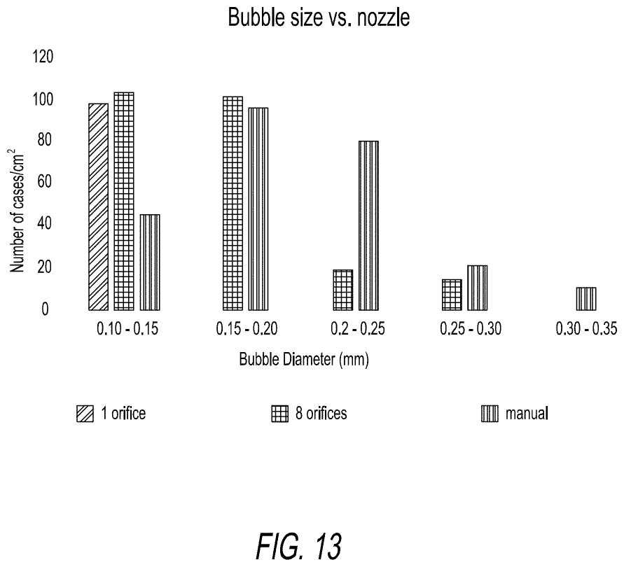

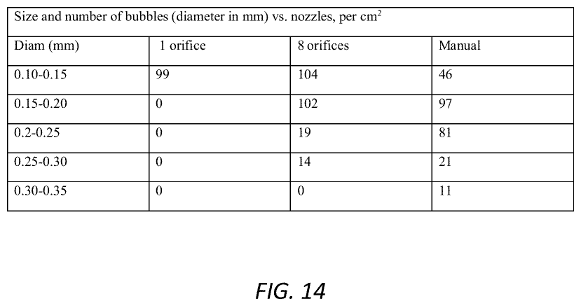

These clear differences translate into an objective quantification of the quality of the emulsion achieved, their values being shown in FIGS. 13 and 14 quantified in an area of 1 cm². It can be seen that the highest percentage in the emulsion produced manually is located in the size ranges of 0.15 to 0.20 and 0.2 to 0.3, even including bubble sizes above this latter range. As for the automatic emulsions obtained, the size of the bubbles decreases, and in the case of the nozzle having a single orifice, the sample contains bubbles of less than 0.15 micron.

What is claimed is:

1. A method for emulsifying milk through a steam lance in machines for making hot beverages, wherein the emulsion is initiated by the user activating the selector switch toggle, by way of which the data stored in at least one memory containing the optimal predetermined parameters that influence the quality of the emulsion are interpreted by the control unit, the process being halted when the temperature of the milk reaches its target temperature, controlling a predetermined time limit that also halts the process, the method making possible a variation in the speed of the pump providing the air flow, as well as the cutting off of the air supply near the end of the cycle, making it possible to homogenize the emulsion, it also being possible for the user to manage these parameters prior to the emulsification by using a visual touch screen; the steam and the air flow through the steam lance passing through a removable nozzle having at least one channel and exit orifice whose orientation differs by an angle of at least 30 degrees from the vertical axis of the lance, the diameter of the orifice being between) about 1.2 to about 1.3 mm; by way of activating the selector switch toggle in another of its positions, the air is halted prior to reaching the final temperature of the desired emulsion; after the emulsion has been produced, the method enables different cleaning modes for the emulsion lance: an internal manual cleaning activated by the user who, by placing the selector switch toggle in another of its positions, opens up the steam valve, causing steam to pass through the lance without operating the air pump; an automatic cleaning that is activated if it is detected that cleaning has not been carried out after a predetermined time; the automatic cleaning is activated if it is detected that cleaning has not been conducted with the sufficient time established as being desirable to guarantee hygiene of the unit; to prevent the risk of burns upon activating the automatic cleaning and to prevent the steam from reaching the user, the method involves a system for detecting the position of the lance such that the cleaning will only be initiated if the lance is in a vertical position in which the steam exits toward the spill collection tray of the machine beyond the reach of the user; if this is not the case, a message is displayed to move into this position.

2. A machine for carrying out the method of claim 1, further comprising a steam lance with means of varying the quality of the emulsion by way of at least one removable outlet nozzle that has a temperature sensor emerging through the latter at its end for measuring the temperature of the milk, and through which there flows the steam coming from a conventional boiler and the air injected from a regulable pump; in having a visual touch screen for interaction with the user and a selector switch toggle to start the functions of emulsification, stoppage, or manual cleaning; in comprising at least one control unit and at least one memory in which are stored the operating data introduced at the factory or by the user, its control logic providing for an automatic cleaning if after a set time no manual cleaning has been carried out or if the time of such cleaning was less than that saved in the memory as being adequate, the measurement being conducted by at least one clock that establishes the time base of the events; in comprising means of preventing the risk of burns to the user during the automatic cycle, operating only if the steam lance is located in the vertical position and the steam is directed toward the spill collection tray, as well as a micro contact switch.

3. (canceled)

4. (canceled)

5. The machine for carrying out the method of claim 2, further wherein the removable outlet nozzle has a single channel and an orifice with an inclination, measured relative to the vertical with respect to the temperature probe about 30°, and whose diameter has a value of about 1.3 mm.

6. The machine for carrying out the method of claim 2, further wherein the removable outlet nozzle has at least 6 channels and orifices with an inclination, measured relative to the vertical with respect to the temperature probe of about 30°, and whose diameters have a value of about 1.2 mm.

7. (canceled)

8. (canceled)
